(19) United States
(12) Patent Application Publication
(10) Pub. No.: US 2015/0138193 A1
(43) Pub. Date: May 21, 2015

(54) METHOD AND DEVICE FOR PANORAMA-BASED INTER-VIEWPOINT WALKTHROUGH, AND MACHINE READABLE MEDIUM

(71) Applicant: Tencent Technology (Shenzhen) Company Limited, Shenzhen (CN)

(72) Inventors: Baoli Li, Shenzhen (CN); Kexin Wu, Shenzhen (CN); Chengjun Li, Shenzhen (CN); Xian Zhang, Shenzhen (CN)

(21) Appl. No.: 14/554,288

(22) Filed: Nov. 26, 2014

Related U.S. Application Data
(63) Continuation of application No. PCT/CN2013/076425, filed on May 29, 2013.

(30) Foreign Application Priority Data
May 29, 2012 (CN) 201210170074.0

(51) Int. Cl. G06T 19/00; G06T 11/60; G06T 15/20; G06T 19/20

(52) U.S. Cl. CPC G06T 19/003; G06T 19/20; G06T 11/60; G06T 15/205
USPC 345/419

(57) ABSTRACT

A method and device for panorama-based inter-viewpoint walkthrough and a machine readable medium are provided. The method includes: selecting a current viewpoint image from a panorama, and obtaining a three-dimensional model of the current viewpoint image; selecting a sub-image from the current viewpoint image to perform a feature detection, so as to obtain feature points of neighboring viewpoints; performing a matching calculation on the feature points of the neighboring viewpoints, and determining a distance between the neighboring viewpoints according to a result of the matching calculation; and performing three-dimensional walkthrough on the three-dimensional model of the current viewpoint image, where a walkthrough depth is the distance between the neighboring viewpoints. After application of the embodiments of the present disclosure, smooth panorama-based inter-viewpoint transition can be realized, and the effect of smooth walkthrough can be enhanced, by accurate determination of distance between the viewpoints.

This application is a continuation of International Application No. PCT/CN2013/076425, filed on May 29, 2013, which claims priority to Chinese Patent Application No. 201210170074.0, filed on May 29, 2012, entitled “METHOD AND DEVICE FOR PANORAMA-BASED INTER-VIEWPOINT WALKTHROUGH”, the contents of each of Which are incorporated by reference herein in their entirety.

### TECHNICAL FIELD

Embodiments of the present disclosure relate to an image processing technology field, and more specifically, to a method and device for panorama-based inter-viewpoint walkthrough, and a machine readable medium.

### BACKGROUND

Due to advantages such as a low hardware requirement and a good sense of reality, panorama-based virtual reality system is currently used more and more widely to various fields. A panorama technology is a type of virtual reality technology, which can simulate an on-site visual feeling that a user is located in a certain location of a real scene with a strong sense of immersion, brings an immersive user experience to the user, and thus has a significant application value.

A viewpoint refers to an observation point of the user in a virtual scene at a certain moment, and plays a role of managing a panorama in generation of the virtual scene. Panorama-based walkthrough is mainly divided into walkthrough within a fixed viewpoint and walkthrough between different viewpoints. A panorama browsing technology of a fixed viewpoint has already been relatively mature, but an effect of walkthrough between different viewpoints is not ideal due to problems such as a panorama scheduling efficiency and a viewpoint transition algorithm, which is mainly because a technology for a smooth transition between viewpoints has not been solved.

Major problems to be solved by the walkthrough technology for a multi-viewpoint panorama virtual space include a speed and a quality of panoramic image browsing, a panorama scheduling efficiency, a viewpoint transition algorithm, etc.

Currently, there is a method attempting to address the panorama walkthrough between different viewpoints by using a Tour Into the Picture (TIP) technology. The method is based on a perspective principle, and is mainly directed to scenes having geometric features of lines, such as building network, a street, etc. It models a two-dimensional picture by using a vanishing point and spidery meshes, determines depth information of the model, and then rebuilds a relative three-dimensional model of the scene so that the user can navigate therein. By combining the TIP technology and the panorama, the user's experience feeling can be effectively enhanced to a certain extent.

If the TIP technology and the panorama are combined, it is necessary to know a distance between viewpoints to achieve an experience feeling of smooth walkthrough, so that when a three-dimensional TIP walkthrough is performed, it can be known which location the walkthrough may reach for a best match with an image of next viewpoint, so as to perform morphing at that time to achieve the effect of smooth walkthrough to a greatest extent. However, in most current circumstances, due to limitation of acquisition accuracy, accuracy of the distance between the viewpoints is not high enough, which greatly restricts the effect of smooth walkthrough.

### SUMMARY

An embodiment of the present disclosure provides a method for panorama-based inter-viewpoint walkthrough including: selecting a current viewpoint image from a panorama, and obtaining a three-dimensional model of the current viewpoint image; selecting a sub-image from the current viewpoint image to perform a feature detection, so as to obtain feature points of neighboring viewpoints; performing a matching calculation on the feature points of the neighboring viewpoints, and determining a distance between the neighboring viewpoints according to a result of the matching calculation; and performing three-dimensional walkthrough on the three-dimensional model of the current viewpoint image, where a walkthrough depth is the distance between the neighboring viewpoints.

Another embodiment of the present disclosure provides a device for panorama-based inter-viewpoint walkthrough, including a three-dimensional model obtaining unit, a feature detection unit, a matching calculation unit and a three-dimensional walkthrough unit, where the three-dimensional model obtaining unit is configured to select a current viewpoint image from a panorama, and obtain a three-dimensional model of the current viewpoint image, the feature detection unit is configured to select a sub-image from the current viewpoint image to perform a feature detection, so as to obtain feature points of neighboring viewpoints, the matching calculation unit is configured to perform a matching calculation on the feature points of the neighboring viewpoints, and determining a distance between the neighboring viewpoints according to a result of the matching calculation, and the three-dimensional walkthrough unit is configured to perform three-dimensional walkthrough on the three-dimensional model of the current viewpoint image, where a walkthrough depth is the distance between the neighboring viewpoints.

Another embodiment of the present disclosure provides a machine readable medium having a set of instructions stored thereon, which, when executed, causes the machine to: select a current viewpoint image from a panorama, and obtain a three-dimensional model of the current viewpoint image; select a sub-image from the current viewpoint image to perform a feature detection, so as to obtain feature points of neighboring viewpoints: perform a matching calculation on the feature points of the neighboring viewpoints, and determine a distance between the neighboring viewpoints according to a result of the matching calculation; and perform three-dimensional walkthrough on the three-dimensional model of the current viewpoint image, where a walkthrough depth is the distance between the neighboring viewpoints.

It can be seen from the above-mentioned technical solutions that, in the embodiments of the present disclosure, firstly, the current viewpoint image is selected from the panorama, and the three-dimensional model of the current viewpoint image is obtained; then, the sub-image is selected from the current viewpoint image to perform the feature detection so as to obtain the feature points of the neighboring viewpoints; the matching calculation is performed on the feature points of the neighboring viewpoints, and the distance between the neighboring viewpoints is determined according to the result of the matching calculation; and finally, the three-dimensional walkthrough is performed on the three-dimensional model of the current viewpoint image, where the walkthrough depth is the distance between the neighboring viewpoints. It can be known that, after application of the embodiments of the present disclosure, smooth panorama-based inter-viewpoint transition can be realized, and the effect of smooth walk-through can be enhanced, by accurate determination of the distance between the viewpoints.

Furthermore, the embodiments of the present disclosure realize the smooth inter-viewpoint walkthrough without increasing a data storage amount, and enhance a sense of reality of a virtual scene significantly, with a moderate algorithm computational amount.

### BRIEF DESCRIPTION OF THE DRAWINGS

FIG. 1 is a flow chart of a method for panorama-based inter-viewpoint walkthrough according to an embodiment of the present disclosure;

FIG. 2 is a schematic diagram of neighboring viewpoint images according to the embodiment of the present disclosure;

FIG. 3 is a first schematic diagram of a TIP algorithm model according to the embodiment of the present disclosure;

FIG. 4 is a second schematic diagram of a TIP algorithm model according to the embodiment of the present disclosure;

FIG. 5 is a schematic diagram of a depth calculation for a TIP algorithm model according to the embodiment of the present disclosure; and

FIG. 6 is a structural diagram of a device for panorama-based inter-viewpoint walkthrough according to an embodiment of the present disclosure.

### DETAILED DESCRIPTION

In order to make objectives, technical solutions and advantages of the present disclosure clearer, the present disclosure will be further described in detail below in conjunction with the accompanying drawings.

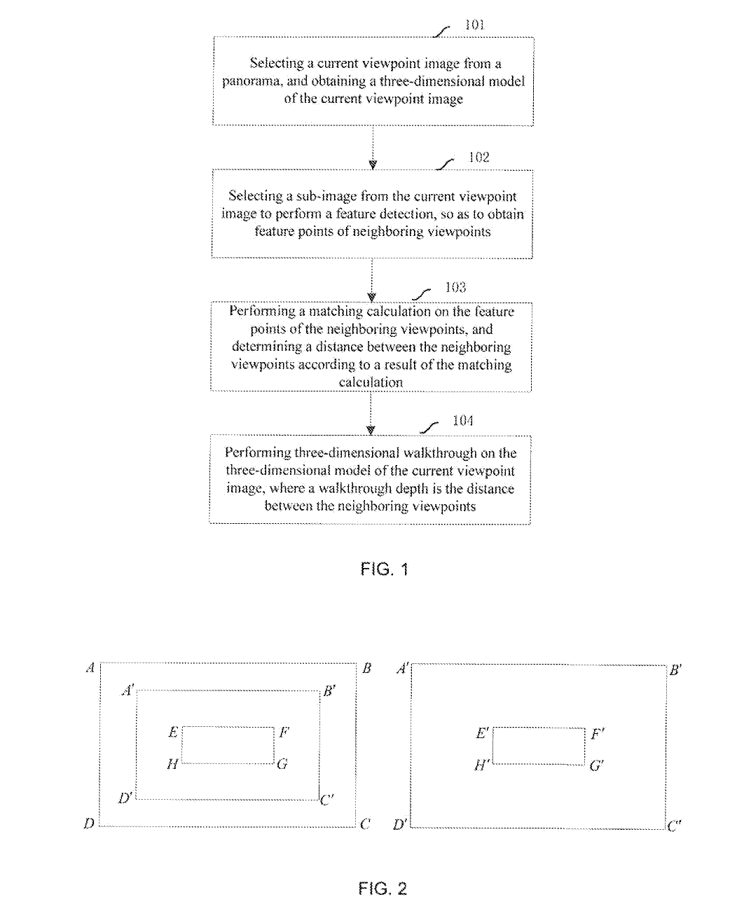

FIG. 1 is a flow chart of a method for panorama-based inter-viewpoint walkthrough according to an embodiment of the present disclosure.

As shown in FIG. 1, in Step 101, a current viewpoint image is selected from a panorama, and a three-dimensional model of the current viewpoint image is further obtained.

The viewpoint in the panorama refers to an observation point of a user in a virtual scene at a certain moment, and plays a role of managing the panorama in generation of the virtual scene. The current viewpoint image is an image observed with respect to the panorama based on the current viewpoint.

Here, the panorama is preferably a panorama of a street view. The panorama of the street view has a lot of geometric features of lines, and is suitable for walkthrough experience of the TIP technology. A combination of the panorama of the street view with the TIP technology can improve a verisimilitude degree of the virtual scene.

In the case of application to the panorama of the street view, firstly, the current viewpoint image may be selected from the panorama of the street view, a three-dimensional modeling is performed by using the TIP technology, and corresponding texture information is generated. The texture information is used to indicate a color mode of an object in the panorama of the street view, and indicate whether a surface of the object is coarse or smooth. The selection of the current viewpoint image should be performed by selecting an image of a fixed scale in a forward direction along a route taken when the image was photographed.

FIG. 2 is a schematic diagram of neighboring viewpoint images according to the embodiment of the present disclosure.

As shown in FIG. 2, a rectangle ABCD is a viewpoint image corresponding to a viewpoint Sₗ, and a rectangle A′B′C′D′ is a viewpoint image corresponding to a viewpoint Sₗ₊₁. Sₗ and Sₗ₊₁, are neighboring viewpoints in the forward direction of photographing.

For the panorama of the street view, the viewpoint image corresponding to the viewpoint Sₗ₊₁ is reflected in the viewpoint image corresponding to the viewpoint Sₗ. As shown in a left half of FIG. 2, the viewpoint image corresponding to the viewpoint Sₗ (i.e., the rectangle ABCD) contains the viewpoint image corresponding to the viewpoint Sₗ₊₁ (i.e., the rectangle A′B′C′D′).

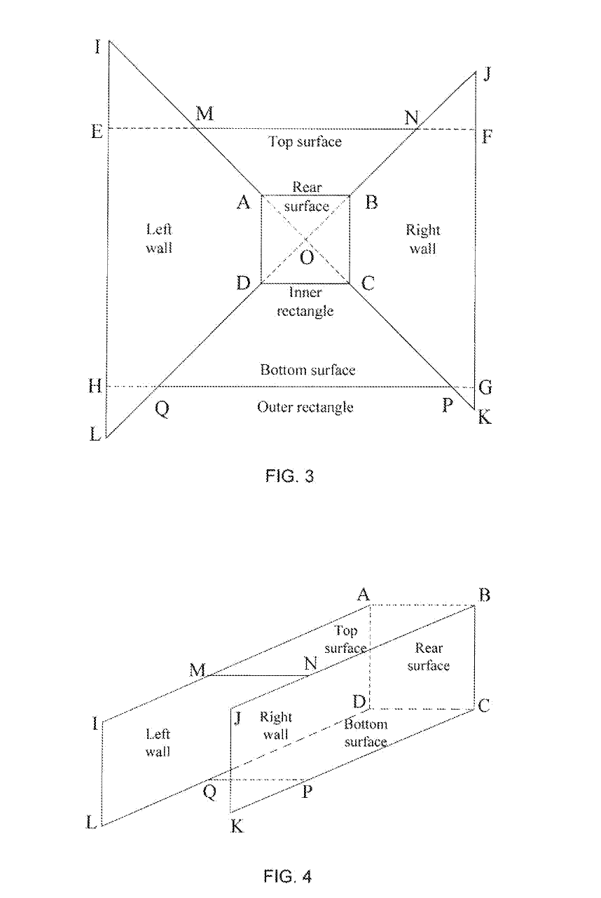

The three-dimensional modeling is performed on the current viewpoint image by the TIP technology, and the models corresponding to the TIP technology are shown in FIG. 3 and FIG. 4, respectively. FIG. 3 is a first schematic diagram of the TIP algorithm model according to the embodiment of the present disclosure, and FIG. 4 is a second schematic diagram of the TIP algorithm model according to the embodiment of the present disclosure.

In FIG. 3, a vanishing point O is an intersection point of straight lines, which are parallel in a three-dimensional space, in the two-dimensional projected image, and spidery meshes are formed by the vanishing point, an inner rectangle, an outer rectangle and a group of radials starting from the vanishing point. The vanishing point is connected with four points of the internal rectangle, and after their radials intersect with the outer rectangle, the models can be divided into five parts, including a left wall, a right wall, a rear surface, a bottom surface, a top surface, etc.

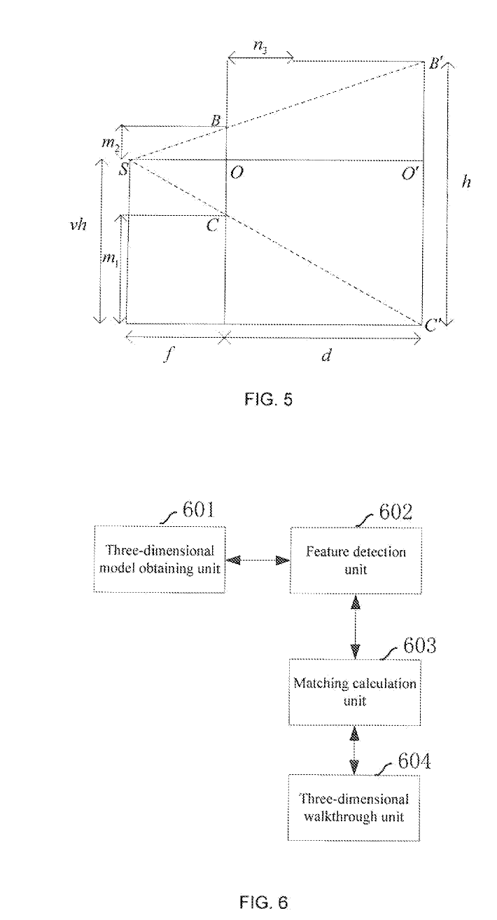

FIG. 5 is a schematic diagram of a depth calculation for the TIP algorithm model according to the embodiment of the present disclosure. Assume that S is the viewpoint, a distance position f of the viewpoint S from a projection plane is determined arbitrarily, O is the vanishing point, a height of the viewpoint S from a ground is vh, SO is a bottom surface of the ground, BC is a height of the inner rectangle of the model, B′C′ is a distance, in the rear surface, from the bottom surface to the top surface, d is a depth of the model, m₁ is a distance from a lower edge of the inner rectangle to the bottom of the image, and m₂ is a distance from an upper edge of the inner rectangle to the vanishing point.

From a geometrical relationship ΔSOC≈ΔSO′C′, a following equation is derived:

$$\frac{vh - {m}_{1}}{f} = \frac{vh}{f + d} , i . e . , d = \frac{{m}_{1} f}{vh - {m}_{1}} ;$$

From a geometrical relationship ΔSOB≈ΔSO′B′, a following equation is derived:

$$\frac{{m}_{2}}{f} = \frac{h - vh}{f + d} , i . e . , h = vh + {m}_{2} + \frac{{m}_{2} d}{f} .$$

On this basis, textures of respective rectangle surfaces in the model are obtained by using a light mapping method. A main concept of the light mapping is to project a three-dimensional object space point onto an image plane of a two-dimensional space to obtain a pixel value of the point.

In Step 102, a sub-image is selected from the current viewpoint image to perform a feature detection, so as to obtain feature points of neighboring viewpoints.

The current viewpoint image is the image observed with respect to the panorama based on the current viewpoint, and contains a sub-image. By selecting the sub-image from the current viewpoint image to perform the feature detection, the feature points of the neighboring viewpoints may be obtained.

For example, as shown in FIG. 2, with respect to the viewpoint Sₗ, the current viewpoint image thereof is the rectangle ABCD, and the rectangle ABCD includes a rectangle EFGH which is just the sub-image of the rectangle ABCD. With respect to the viewpoint Sₗ₊₁, the current viewpoint image thereof is the rectangle A′B′C″D′, and the rectangle A′B′C′D′ contains a rectangle E′F′G′H′ which is just the sub-image of the rectangle A′B′C′D′.

Here, the sub-image is preferably selected from the current viewpoint image, and the feature detection is performed on the sub-image by a Scale Invariant Feature Transform (SIFT) algorithm. The SIFT algorithm has invariance for translation, rotation and scale changes, as well as good robustness against noises, viewpoint changes, illumination changes, and so on.

A purpose of selecting the sub-image to perform the SIFT feature detection is mainly to improve a calculation efficiency. However, the selected sub-image should not be too small, otherwise the detected feature points will be too few, affecting a matching accuracy.

A specific implementation of the SIFT feature detection may include the following operations.

(1) Detecting an Extremum in a Scale Space

The viewpoint image is convolved with Gauss functions with different kernels to obtain corresponding Gauss images, where a two-dimensional Gauss function is defined as:

$$G ( x , y , σ ) = \frac{1}{2 π {σ}^{2}} {e}^{- ( {x}^{2} + {y}^{2} ) \text{/} 2 {σ}^{2}}$$

where σ is called a variance of the Gauss Function, and x and y are two dimensions, i.e. row and column, of the image, respectively.

A difference operation is performed on the Gauss images formed by two Gauss functions with a factor difference k, so that a Difference of Gaussian (DoG) scale space of the images as expressed below is formed:

D(x,y,σ)=(G(x,y,kσ)−G(x,y,σ)*l(x,y)=L(x,y,kσ)−L(x,y,σ)

Taking three neighboring scales of the DoG scale space, each pixel point in a middle layer is compared with pixel points at neighboring positions in the same layer, an upper layer and a lower layer one by one. if the point is a maximum value or a minimal value, the point is treated as a candidate feature point under this scale.

(2) Locating the Feature Points

Since a DoG value is sensitive to noises and an edge, it is necessary to, for the local extremum points, determine positions and scales of the candidate feature points precisely by using a Taylor series expansion equation, and meanwhile remove low-contrast feature points.

(3) Determining a Principal Direction of the Feature Points

A purpose of determining the principal direction of the feature points is mainly for feature point matching. After the principal direction is identified, the image can be rotated to the principal direction when the feature point matching is performed, so as to ensure rotational invariance of the image. A gradient value and a direction at a pixel point (x,y) are respectively:

$$m ( x , y ) = \sqrt{{( L ( x + 1 , y ) - L ( x - 1 , y ) )}^{2} + {( L ( x , y + 1 ) - L ( x , y - 1 ) )}^{2}} ;$$

$$θ ( x , , y ) = arctan \frac{2 ( L ( x , y + 1 ) - L ( x , y - 1 ) )}{L ( x + 1 , y ) - L ( x - 1 , y )} ,$$

where m(x,y) denotes an energy of the direction, and θ(x,y) denotes the direction.

Sampling is performed within neighborhood windows with the feature points as centers, a gradient direction histogram is used to collect statistics on gradient directions of neighborhood pixels, and a direction corresponding to a highest peak point in the histogram is the principal direction. So far, the feature point detection for the image has been completed, and each feature point has three pieces of information, i.e. a position, a corresponding scale and a direction.

(4) Generating an SIFT Feature Descriptor

The SIFT algorithm generates the feature descriptor in a manner of sampling region. In order to ensure the rotational invariance, a coordinate axis may be firstly rotated to the direction of the feature point, a 8×8 window is taken with the feature point as a center, then gradient direction histograms in 8 directions are calculated on a small 4×4 image block, and an accumulated value of each of the gradient directions is drawn to form a seed point. Then, one feature point is described by 16 seed points, and each of the seed points has vector information in the 8 directions, so that for each feature point, 16×8=128 data in total may be generated, that is, a 128-dimensional SIFT feature descriptor is formed.

In Step 103, a matching calculation is performed on the feature points of the neighboring viewpoints, and a distance between the neighboring viewpoints is determined according to a result of the matching calculation.

Preferably, a Random Sample Consensus (RANSAC) algorithm may be applied here to perform the matching calculation on the feature points of the neighboring viewpoints.

In one embodiment, the matching calculation is performed on the feature points of the neighboring viewpoints firstly so as to obtain a planar perspective transformation matrix, and then the planar perspective transformation matrix is used to determine the distance between the neighboring viewpoints.

Specifically, when the RANSAC algorithm is adopted, an inherent constraint relation of the set of the feature points is utilized to generate optimal data consistency, so as to further eliminate mismatching.

Assuming that a coordinate of the feature point in an image 1 is (x,y), which becomes (x′,y′) after being converted to a coordinate system of an image 2, a corresponding relation between (x,y) and (x′,y′) may be represented by the planar perspective transformation matrix H:

$$[ \begin{matrix}x \\ y \\ 1\end{matrix} ] = [ \begin{matrix}{a}_{0} & {a}_{1} & {a}_{2} \\ {a}_{3} & {a}_{4} & {a}_{5} \\ {a}_{6} & {a}_{7} & 1\end{matrix} ] [ \begin{matrix}{x}^{′} \\ {y}^{′} \\ 1\end{matrix} ] , where$$

$$H = [ \begin{matrix}{a}_{0} & {a}_{1} & {a}_{2} \\ {a}_{3} & {a}_{4} & {a}_{5} \\ {a}_{6} & {a}_{7} & 1\end{matrix} ]$$

Given a data set P which is composed by N pairs of candidate matching points, the RANSAC algorithm may include steps of:

(1) randomly selecting 4 pairs of candidate matching points from P, and solving H by a least square;

(2) setting a threshold value T, calculating distances from the other N−4 pairs of candidate matching points to the model, grouping points which satisfy d(Pₗ, HP′ₗ)<T into a matching point set, and recording a number of corresponding points as n;

(3) repeating the above process for k times, and selecting a point set with a maximum n from the k matching point sets as an inner point set; and

(4) recalculating the planar perspective transformation matrix H according to the inner point set.

A distance for walkthrough from the TIP model corresponding to the viewpoint Sₗ to the TIP sub-image corresponding to the viewpoint Sₗ₊₁ calculated. By the obtained planar perspective transformation matrix H, coordinates of four vertexes A′, B′, C′ and D′ of the viewpoint image of the viewpoint Sₗ₊₁ in the viewpoint image of the viewpoint Sₗ can be calculated. By using the modeling result in Step 101 and the light mapping method, a depth m of the point A′ in the TIP three-dimensional model corresponding to the viewpoint Sₗ can be derived.

In Step 104, three-dimensional walkthrough is performed on the three-dimensional model of the current viewpoint image, where a walkthrough depth is the distance between the neighboring viewpoints.

Here, the three-dimensional walkthrough is performed on the viewpoint image established for the viewpoint Sₗ, and when a longitudinal walkthrough depth is m, the morphing is performed by interpolation to obtain the viewpoint image corresponding to Sₗ₊₁, so as to achieve smooth walkthrough between the viewpoints.

The image feature extracting algorithm has been described in detail above by taking the SIFT Algorithm as example, and the feature point matching algorithm has been described in detail by taking the RANSAC Algorithm as example.

It can be seen that after the embodiment of the present disclosure is applied, by selecting the sub-image to perform the feature detection, performing the matching calculation on the feature points of the neighboring viewpoints, and determining the distance between the neighboring viewpoints according to the result of the matching calculation, the embodiment of the present disclosure can determine the distance between the viewpoints precisely, and realize smooth panorama-based inter-viewpoint transition, thereby improving the effect of smooth walkthrough.

It can be appreciated by those skilled in the art that these examples are merely exemplary, and are not intended to limit the protection scope of the embodiment of the present disclosure. Actually, the image feature extracting algorithm and the feature point matching algorithm may have many implementations, and are not specifically limited by the embodiment of the present disclosure.

Based on the above detailed analysis, an embodiment of the present disclosure further provides a device for panorama-based inter-viewpoint walkthrough.

FIG. 6 is a structural diagram of the device for panorama-based inter-viewpoint walkthrough according to the embodiment of the present disclosure.

As shown in FIG. 6, the device includes a three-dimensional model obtaining unit 601, a feature detection unit 602, a matching calculation unit 603 and a three-dimensional walkthrough unit 604.

The three-dimensional model obtaining unit 601 is configured to select a current viewpoint image from a panorama, and obtain a three-dimensional model of the current viewpoint image.

The feature detection unit 602 is configured to select a sub-image from the current viewpoint image to perform a feature detection, so as to obtain feature points of neighboring viewpoints.

The matching calculation unit 603 is configured to perform a matching calculation on the feature points of the neighboring viewpoints, and determine a distance between the neighboring viewpoints according to a result of the matching calculation.

The three-dimensional walkthrough unit 604 is configured to perform three-dimensional walkthrough on the three-dimensional model of the current viewpoint image, where a walkthrough depth is the distance between the neighboring viewpoints.

In one embodiment, the feature detection unit 602 is configured to select a sub-image from the current viewpoint image, and perform the feature detection on the sub-image by a SIFT Algorithm.

In one embodiment, the matching calculation unit 603 is configured to perform the matching calculation on the feature points of the neighboring viewpoints by a RANSAC Algorithm.

In one embodiment, the matching calculation unit 603 is configured to performing the matching calculation on the feature points of the neighboring viewpoints, so as to obtain a planar perspective transformation matrix, and determine the distance between the neighboring viewpoints using the planar perspective transformation matrix.

Moreover, in one embodiment, the three-dimensional model obtaining unit 601 is configured to select the current viewpoint image from the panorama, and perform a three-dimensional modeling on the current viewpoint image using a TIP algorithm, so as to obtain the three-dimensional model of the current viewpoint image.

To sum up, in the embodiments of the present disclosure, firstly the current viewpoint image is selected from the panorama, and the three-dimensional model of the current viewpoint image is obtained; then the sub-image is selected from the current viewpoint image to perform the feature detection, so as to obtain the feature points of the neighboring viewpoints; then the matching calculation is performed on the feature points of the neighboring viewpoints, and the distance between the neighboring viewpoints is determined according to the result of the matching calculation; finally, three-dimensional walkthrough is performed on the three-dimensional model of the current viewpoint image, where the walkthrough depth is the distance between the neighboring viewpoints. It can be seen that, after application of the embodiments of the present disclosure, smooth panorama-based inter-viewpoint transition can be realized, and the effect of smooth walkthrough can be enhanced, by an accurate determination of the distance between the viewpoints.

Furthermore, the embodiments of the present disclosure realize the smooth inter-viewpoint walkthrough without increasing a data storage amount, and enhance the user's experience feeling significantly, with a moderate algorithm computational amount.

An embodiment of the present disclosure further provides a machine readable medium having a set of instructions stored thereon, which, when executed, causes the machine to execute the method of any of the above embodiments. The machine readable medium may be a floppy disk, a hard disk, an optical disk or the like of a computer, and the machine may be a mobile phone, a personal computer, a server, a network device or the like.

Specifically, the machine readable medium has a set of instructions stored thereon, which, when executed, causes the machine to: select a current viewpoint image from a panorama, and obtain a three-dimensional model of the current viewpoint image; select a sub-image from the current viewpoint image to perform a feature detection, so as to obtain feature points of neighboring viewpoints; perform a matching calculation on the feature points of the neighboring viewpoints, and determine a distance between the neighboring viewpoints according to a result of the matching calculation and performing three-dimensional walkthrough on the three-dimensional model of the current viewpoint image, where a walkthrough depth is the distance between the neighboring viewpoints.

In one embodiment of the machine readable medium, when the set of instructions are executed, the machine's selecting a sub-image from the current viewpoint image to perform a feature detection includes: selecting the sub-image from the current viewpoint image and performing the feature detection on the sub-image using a SIFT Algorithm.

In one embodiment of the machine readable medium, when the set of instructions are executed, the machine's performing a matching calculation on the feature points of the neighboring viewpoints includes: performing the matching calculation on the feature points of the neighboring viewpoints using a RANSAC Algorithm.

In one embodiment of the machine readable medium, when the set of instructions are executed, the machine's performing a matching calculation on the feature points of the neighboring viewpoints, and determining a distance between the neighboring viewpoints according to a result of the matching calculation includes: performing the matching calculation on the feature points of the neighboring viewpoints, so as to obtain a planar perspective transformation matrix; and determining the distance between the neighboring viewpoints using the planar perspective transformation matrix.

In one embodiment of the machine readable medium, when the set of instructions are executed, the machine's selecting a current viewpoint image from a panorama, and obtaining a three-dimensional model of the current viewpoint image includes: selecting the current viewpoint image from the panorama, and performing a three-dimensional modeling on the current viewpoint image using a TIP algorithm, so as to obtain the three-dimensional model of the current viewpoint image.

The above are only preferred embodiments of the present disclosure, and are not intended to limit the protection scope of the present disclosure. Any modification, equivalent alternation and improvement without departing from the spirit and principle of the present disclosure shall be included within the protection scope of the present disclosure.

It is to be noted that, each of the aforementioned embodiments of the method is described as a combination of a series of actions for simplicity of description, however, those skilled in the art should understand that the present disclosure is not limited by a sequence of the actions described, because according to the present disclosure, some steps may be executed in other sequences or simultaneously. Secondly, those skilled in the art should also understand that the embodiments described in the specification belong to preferred embodiments, and the actions and modules involved are not always essential in the present disclosure.

The respective embodiments in the above-described embodiments are described with difference focuses. For a part of one of the embodiments that is not described in detail, related descriptions in other embodiments may be referred to.

Those of ordinary skill in the art can understand that all or a part of the steps for implementing the above method embodiments can be performed by program instruction-related hardware, and the program can be stored in a computer-readable storage medium, and when executed, can execute the steps included in the method embodiments. The storage medium may include various medium which can store program codes, such as a ROM/RAM, a magnetic disk, an optical disk, or the like.

Finally, it is to be noted that the above embodiments are only used to illustrate the technical solutions of the present disclosure, and are not intended to limit the present disclosure. Although the present disclosure has been described in detail with reference to the above embodiments, those of ordinary skill in the art should understand that they can make modifications to the technical solutions described in the above respective embodiments, or make equivalent replacements to a part of technical features therein, and such modifications or replacements do not render the essence of the corresponding technical solutions to depart from the spirit and principle of the technical solutions of the respective embodiments of the present disclosure.

What is claimed is:

1. A method for panorama-based inter-viewpoint walkthrough, comprises:
selecting a current viewpoint image from a panorama, and obtaining a three-dimensional model of the current viewpoint image;
selecting a sub-image from the current viewpoint image to perform a feature detection, so as to obtain feature points of neighboring viewpoints;
performing a matching calculation on the feature points of the neighboring viewpoints, and determining a distance between the neighboring viewpoints according to a result of the matching calculation; and
performing three-dimensional walkthrough on the three-dimensional model of the current viewpoint image, where a walkthrough depth is the distance between the neighboring viewpoints.

2. The method of claim 1, wherein the selecting a sub-image from the current viewpoint image to perform a feature detection comprises:
selecting the sub-image from the current viewpoint image, and performing the feature detection on the sub-image using a Scale Invariant Feature Transform algorithm.

3. The method of claim 1, wherein the performing a matching calculation on the feature points of the neighboring viewpoints comprises:
performing the matching calculation on the feature points of the neighboring viewpoints using a Random Sample Consensus algorithm.

4. The method of claim 1, wherein the performing a matching calculation on the feature points of the neighboring viewpoints, and determining a distance between the neighboring viewpoints according to a result of the matching calculation comprises:
performing the matching calculation on the feature points of the neighboring viewpoints, so as to obtain a planar perspective transformation matrix; and
determining the distance between the neighboring viewpoints using the planar perspective transformation matrix.

5. The method of claim 1, wherein the selecting a current viewpoint image from a panorama, and obtaining a three-dimensional model of the current viewpoint image comprises:
selecting the current viewpoint image from the panorama, and performing a three-dimensional modeling on the current viewpoint image using a Tour into the Picture algorithm, so as to obtain the three-dimensional model of the current viewpoint image.

6. A device for panorama-based inter-viewpoint walkthrough, comprising:
a three-dimensional model obtaining unit, configured to select a current viewpoint image from a panorama, and obtain a three-dimensional model of the current viewpoint image;
a feature detection unit, configured to select a sub-image from the current viewpoint image to perform a feature detection, so as to obtain a feature point of neighboring viewpoints;
a matching calculation unit, configured to perform a matching calculation on the feature points of the neighboring viewpoints, and determine a distance between the neighboring viewpoints according to a result of the matching calculation; and
a three-dimensional walkthrough unit, configured to perform three-dimensional walkthrough on the three-dimensional model of the current viewpoint image, where a walkthrough depth is the distance between the neighboring viewpoints.

7. The device of claim 6, wherein the feature detection unit is configured to select the sub-image from the current viewpoint image, and perform the feature detection on the sub-image using a Scale Invariant Feature Transform algorithm.

8. The device of claim 6, wherein the matching calculation unit is configured to perform the matching calculation on the feature points of the neighboring viewpoints using a Random Sample Consensus algorithm.

9. The device of claim 6, wherein, the matching calculation unit is configured to perform the matching calculation on the feature points of the neighboring viewpoints, so as to obtain a planar perspective transformation matrix, and determine the distance between the neighboring viewpoints using the planar perspective transformation matrix.

10. The device of claim 6, wherein the three-dimensional model obtaining unit is configured to select the current viewpoint image from the panorama, and perform a three-dimensional modeling on the current viewpoint image using a Tour Into the Picture algorithm, so as to obtain the three-dimensional model of the current viewpoint image.

11. A machine readable medium having a set of instructions stored thereon, which when executed, causes the machine to:
select a current viewpoint image from a panorama, and obtain a three-dimensional model of the current viewpoint image;
select a sub-image from the current viewpoint image to perform a feature detection, so as to obtain a feature point of neighboring viewpoints;
perform a matching calculation on the feature points of the neighboring viewpoints, and determine a distance between the neighboring viewpoints according to a result of the matching calculation; and
perform three-dimensional walkthrough on the three-dimensional model of the current viewpoint image, where a walkthrough depth is the distance between the neighboring viewpoints.

12. The machine readable medium of claim 11, wherein when the set of instructions is executed, the machine's selecting a sub-image from the current viewpoint image to perform a feature detection is:
selecting the sub-image from the current viewpoint image, and performing a feature detection for the sub-image using a Scale Invariant Feature Transform algorithm.

13. The machine readable medium of claim 11, wherein when the set of instructions is executed, the machine's performing a matching calculation on the feature points of the neighboring viewpoints comprises:
performing the matching calculation on the feature points of the neighboring viewpoints using a Random Sample Consensus algorithm.

14. The machine readable medium of claim 11, wherein when the set of instructions is executed, the machine's performing a matching calculation on the feature points of the neighboring viewpoints, and determining a distance between the neighboring viewpoints according to a result of the matching calculation comprises:
performing the matching calculation on the feature points of the neighboring viewpoints, so as to obtain a planar perspective transformation matrix; and
determining the distance between the neighboring viewpoints using the planar perspective transformation matrix.

15. The machine readable medium of claim 11, wherein when the set of instructions is executed, the machine's selecting a current viewpoint image from a panorama, and obtaining a three-dimensional model of the current viewpoint image comprises:
selecting the current viewpoint image from the panorama, and performing a three-dimensional modeling on the current viewpoint image using at Tour Into the Picture algorithm, so as to obtain the three-dimensional model of the current viewpoint image.
